(19) United States
(12) Patent Application Publication
(10) Pub. No.: US 2012/0256059 A1
(43) Pub. Date: Oct. 11, 2012

(54) Interchangeable Self-Locking Spring Loaded Quick Connect Apparatus for Wire Rope Cable and the Like

(75) Inventors: Andrew G. TOIMIL, Oakland, CA (US); George SHEVCHUK, Oakland, CA (US)

(73) Assignee: Feeney, Inc., Holbrook, NY (US)

(21) Appl. No.: 13/527,484

(22) Filed: Jun. 19, 2012

Related U.S. Application Data
(63) Continuation of application No. 12/904,121, filed on Oct. 13, 2010, now abandoned.
(60) Provisional application No. 61/278,891, filed on Oct. 14, 2009.

(51) Int. Cl. F16L 3/10; F16B 2/20

(52) U.S. Cl. 248/74.2; 248/74.4

(57) ABSTRACT

An interchangeable, self-locking, cable gripping and adaptive anchoring apparatus comprising a gripping component and adaptor component. The adaptor component comprises a receiving side for a fitting or anchoring device, and connector side to engage with cable or the like. The gripping component comprises a housing having a cable receiving end and dispatching end. The housing holds cable gripping elements comprising a spring, spacer and two jaws, within a tapering bore of the housing. At the dispatching end, the housing comprises an internal bore for engaging around the connector side of the adaptor component. The gripping component is spring-loaded and self-locking for securing a cable. The pressure of the adaptor component connector side against the spring, spacer and jaws, lock the inserted cable in place to only allow the cable to move in one direction. The adaptor component engages flush against the housing and securely to contain the housing components.

### CROSS REFERENCE TO RELATED APPLICATIONS

This application is a continuation of U.S. patent application Ser. No. 12/904,121 which was filed with the U.S. Patent and Trademark Office on Oct. 13, 2010. This application claims the benefit of U.S. Provisional Application No. 61/278,891, filed Oct. 14, 2009.

### BACKGROUND OF THE INVENTION

1. Field of the Invention

The present invention generally relates to an apparatus for securing a variety of cables to structures. In particular, there is a cable gripping and adapter apparatus for securing cable and interchangeably connect with a variety of anchoring devices.

2. Description of the Related Art

Cable assemblies are used for various structures or enclosures such as railing and fence applications, both indoor and outdoor, in various residential and commercial settings. Such assemblies are laced through posts, including intermediate posts of a railing frame and tensioned at opposite end posts. These cable assemblies are intended to be attractive and custom designed, and thereby use varying diameters of cable such as slender, unobtrusive cable to allow for unimpaired views. In many railings and architectural designs, special types of cable and fittings may be required to fabricate a custom assembly. These custom assemblies involve various anchoring devices depending on the specific design or functional requirement of the structure. In order to achieve these objectives, many custom designed assemblies require expensive and time consuming installation due to the various design concerns and requirements of various anchoring devices. Such expense and time is further increased in circumstances where there is a need to change the anchoring device.

The aim for many cable assemblies is to provide a durable, low maintenance, versatile, and attractive railing that is easy and quick to install. Therefore, there is a need to increase efficiency and ease in using such custom assemblies to securely grip cables and quickly adapt to a variety of anchoring devices as circumstances may require, while maintaining an attractive and finished look of the assembly. There exists a need for a flexible, versatile apparatus which will interface as a fitting with a multitude of hardware items as well as accommodate a wide spectrum of applications. Therefore, there exists a need for an apparatus adapted to both securely tension or grip cable with a self-locking connector device and interchangeably adapt to a cable fitting, while being attractive and easy to use.

Further objects of the invention will become apparent from the following description.

### SUMMARY OF THE INVENTION

The embodiments of the present invention solve the problems and address the drawbacks of the approaches in the above description.

It is an object of the present invention to provide a novel spring loaded self-locking connection apparatus that will hold a length of wire rope cable and the like securely.

Another object of the present invention is to provide an apparatus of the type described that by inserting a wire rope cable in one of the end openings of the connector device will allow movement of the wire rope cable and the like in one direction and prevent movement in the other direction.

Yet another object of the present invention is to provide a means of adapting the many different anchoring devices available for such an apparatus of the type described.

An object according to an embodiment of the present invention includes a means by which an installer is able to interchange anchoring devices easily by exchanging threaded adapters at the opposite end from the cable receiving end of a self-locking spring loaded apparatus for quick connection to a cable.

An important advantage of the present invention is that once affixed, the anchoring device of the apparatus can still be interchanged time and again. Adjustments to a cable or the anchor are therefore simplified.

Yet another important advantage of the present invention is that the apparatus itself needs no enclosure and can be affixed internally or externally of an enclosure. The apparatus is therefore sleek and attractive looking, able to accommodate a variety of types, diameters and fittings of cables.

In an embodiment of the present invention, the apparatus comprises a cable gripping component and an interchangeable adaptor component. The adaptor component comprises an adaptor housing having a receiving side for a fitting or anchoring device, and a connector side for engaging with the cable component of the apparatus. The cable gripping component comprises a housing having a cable receiving end and a dispatching end. The housing holds the cable gripping elements within a passageway of the housing. At the dispatching end, the housing comprises an internal bore for engaging with the connector side of the adaptor component.

In an embodiment of the present invention, cable material enters the cable gripping component of the apparatus from the receiving end. The pressure from the cable material causes a pair of jaws to open, thus allowing the cable to enter the apparatus. The pressure from the cable also causes a spring to be compressed at the dispatching end against the adaptor component, and which applies pressure against a spacer which in turn presses against the jaws against the cable. In another embodiment, the passageway of the housing comprises a part straight bore section closest to the dispatching end and a part conically tapering bore section to a smaller diameter at the receiving end. The jaws slide longitudinally toward the dispatching end and begin to separate. As the jaws open, the cable is received through the passageway until the spring is expanded. The applied pressure of the spring to the spacer and the spacer to the jaws keeps the receiving end of the jaws in place by causing the jaws to close, thus securely gripping the cable. Thus, the cable is locked within the apparatus and can only move from the receiving end to the dispatching end. The adaptor component of the apparatus is securely connected within the housing of the gripping component. The adaptor component allowing for advantageous interchangeability and therefore versatility in connection with a variety of anchoring devices.

According to another embodiment, there is an apparatus for gripping and anchoring a cable comprising: (1) a first component including a housing for containing a plurality of cable gripping elements, the housing having a passageway, a receiving end and a dispatching end, the gripping elements receive the cable through the receiving end and passageway, preventing the cable from moving back out in an opposite direction; and (2) a second component having an open end, a central bore, and a closed end, a portion of the second component at the closed end is configured for secure attachment by insertion into the dispatching end of the first component, the second component configured for adapting interchangeably with a plurality of types of anchoring devices inserted through the open end and into the central bore, and the closed end positioned adjacent to the gripping elements contained inside the housing at the dispatching end.

These and other objects, advantages and embodiments of the present invention are further made apparent, in the remainder of the present document, to those of ordinary skill in the art.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a perspective view of an interchangeable self-locking spring loaded connection apparatus, according to an embodiment of the present invention.

FIG. 2 is an exploded view illustrating several components of the apparatus depicted in assembled form in FIG. 1, according to an embodiment of the present invention.

FIG. 3 is a plan view of the apparatus as illustrated in FIG. 1.

FIG. 4 is a cross-sectional view taken along the line 5-5 of FIG. 2, illustrating an inside configuration of the adaptor component of the apparatus, according to an embodiment of the present invention.

FIG. 5 is a cross-sectional view taken along the line 6-6 of FIG. 2, illustrating an inside configuration of the cable gripping component of the apparatus, according to an embodiment of the present invention.

FIG. 6 is a cross-sectional view taken along the line 4-4 of FIG. 1, illustrating the components contained within the assembly of the apparatus, according to an embodiment of the present invention.

FIG. 7 is an exploded perspective view of the apparatus illustrating connection with sample accessories at each end respectively, according to an embodiment of the present invention.

FIG. 8 is an assembled perspective view of the apparatus as shown in FIG. 7, according to an embodiment of the present invention.

FIG. 9 illustrates a perspective view of the apparatus with sample accessories as illustrated in FIG. 8 with cross-section of the apparatus taken along the line 4-4 of FIG. 1, according to another embodiment of the present invention.

FIG. 10 is a side elevational view of the apparatus as shown in FIG. 9.

### DETAILED DESCRIPTION OF THE PRESENTLY PREFERRED EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

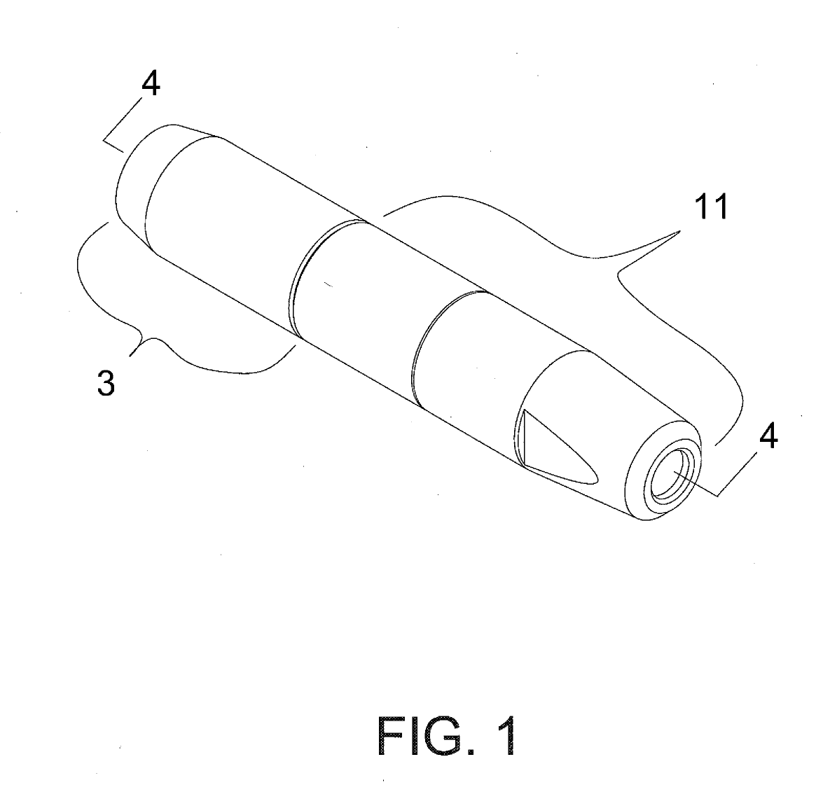

As shown in FIG. 1 there is a perspective view of the interchangeable self-locking spring loaded quick connect apparatus, according to an embodiment of the present invention. The apparatus is in a full assembled state and comprises an adaptor component 3 and a gripping component contained within a housing 11. The adaptor component 3 is interchangeably adaptable to a variety of fittings such as anchoring devices for cables. The housing 11 comprises a self-locking and spring loaded gripping component for receiving and securing a cable of the like of varying type and diameters. The adaptor component 3 and housing 11 are engaged securely and nearly seamlessly to provide a sleek look allowing for the apparatus to be affixed externally from a structure or enclosure.

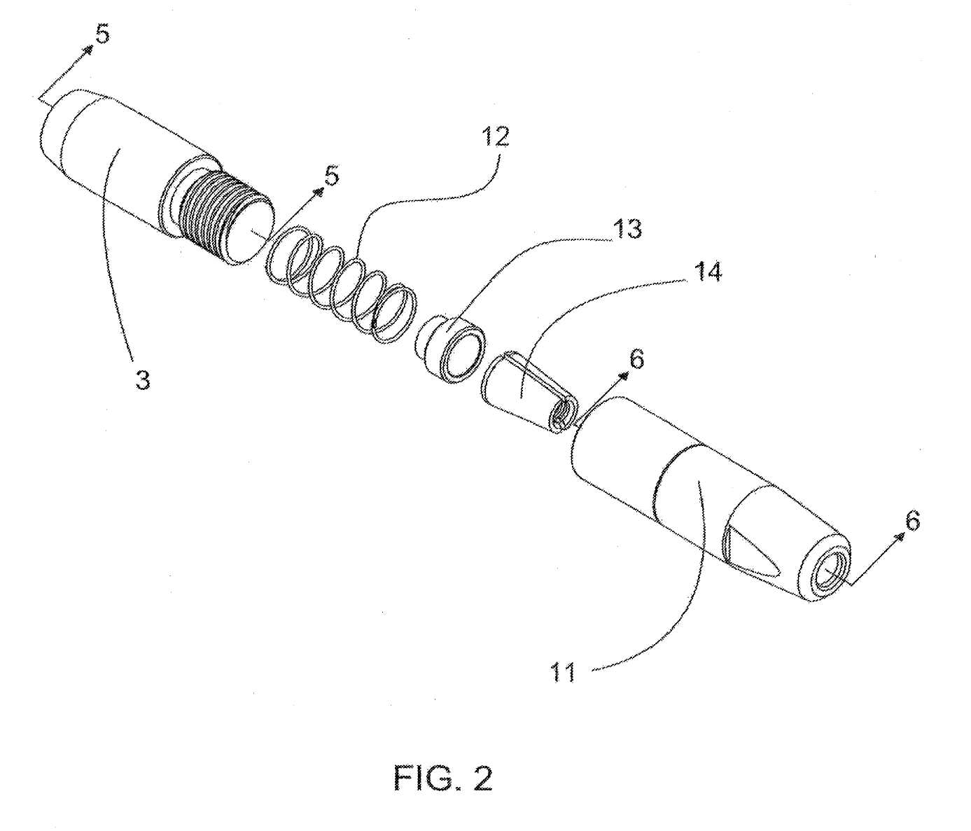

As illustrated in FIG. 2, the apparatus is shown in exploded view illustrating several components of the apparatus as depicted in the assembled form in FIG. 1, according to an embodiment of the present invention. The housing 11 comprises a central passageway or bore within which a pair of half jaws 14, a spacer 13 and a spring 12 resides. The spring 12 is compressible within the housing 11 on one side against the flange 21 of the spacer 13 and on the other side against the adaptor component 3 when assembled.

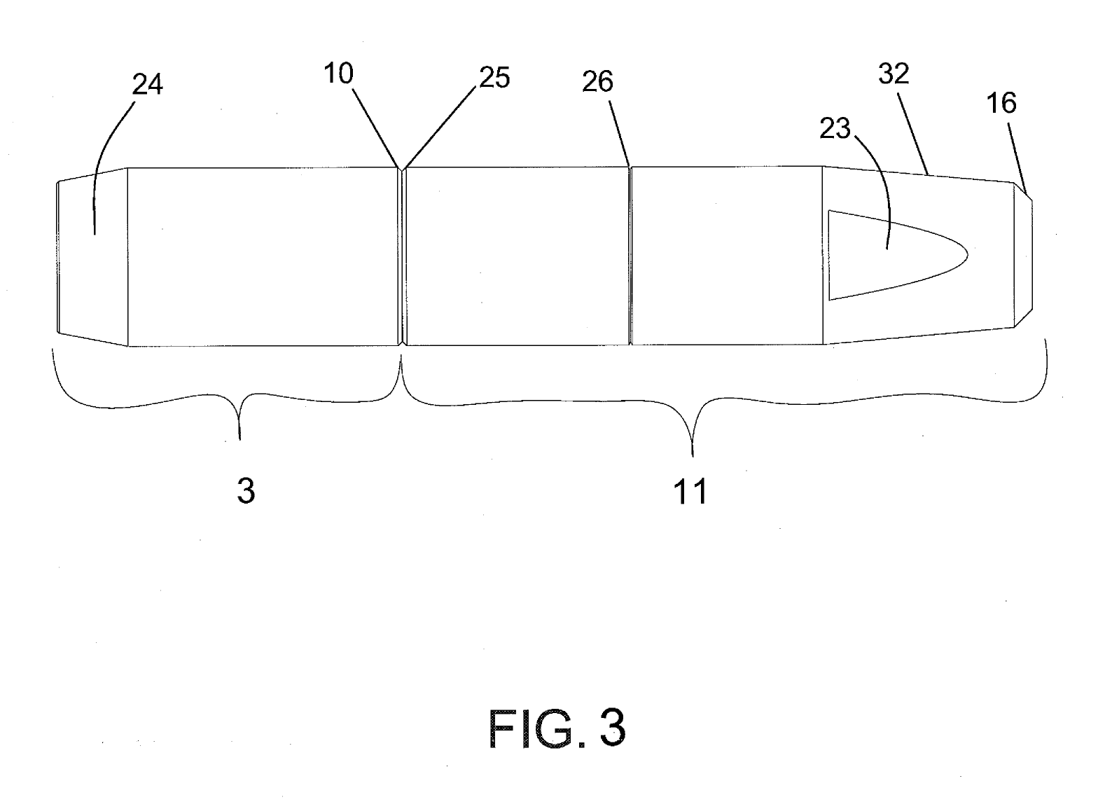

FIG. 3 shows a plan view of the apparatus as illustrated in FIG. 1 in an assembled state showing the engagement of the adaptor component 3 with the housing 11 at a the respective chamfered contact of the adaptor edge 10 and the housing contact edge 25. The adaptor component 3 comprises a receiving side 9 for a fitting and a connector side for the housing 11. A groove or chamfer 26 is further demarcated on the housing 11. This groove 26 serves as a reference mark or gauge. Once a given fitting or anchoring assembly is attached to the receiving side 9 of the adaptor 3, it may be necessary to trim excess cable prior to inserting cable into the housing 11. The groove 26 is used as a reference mark to insure proper or sufficient insertion length of the cable into the housing 11. During the installation of the cable, the installer would pull out excess slack and overlay the cable across the apparatus and mark (for instance with a permanent marker) the cable at the reference mark or gauge point of groove 26. The cable would then be trimmed or cut at that mark and ultimately inserted into the housing 11. The outer surface of the receiving side of the adaptor component 3 has a beveled tapering end 24. The housing 11 comprises a tapered end 32 as well as a beveled end surface 16 for receiving a cable. The tapered end 32 of the housing further comprises a pair of wrench flats 23, on opposing surfaces of the tapered end 32. The flats 23 serve as a means for stability for an installer to hold onto the housing 11 of the apparatus to prevent any rotation of the apparatus during the installation of an accessory fitting or anchoring device.

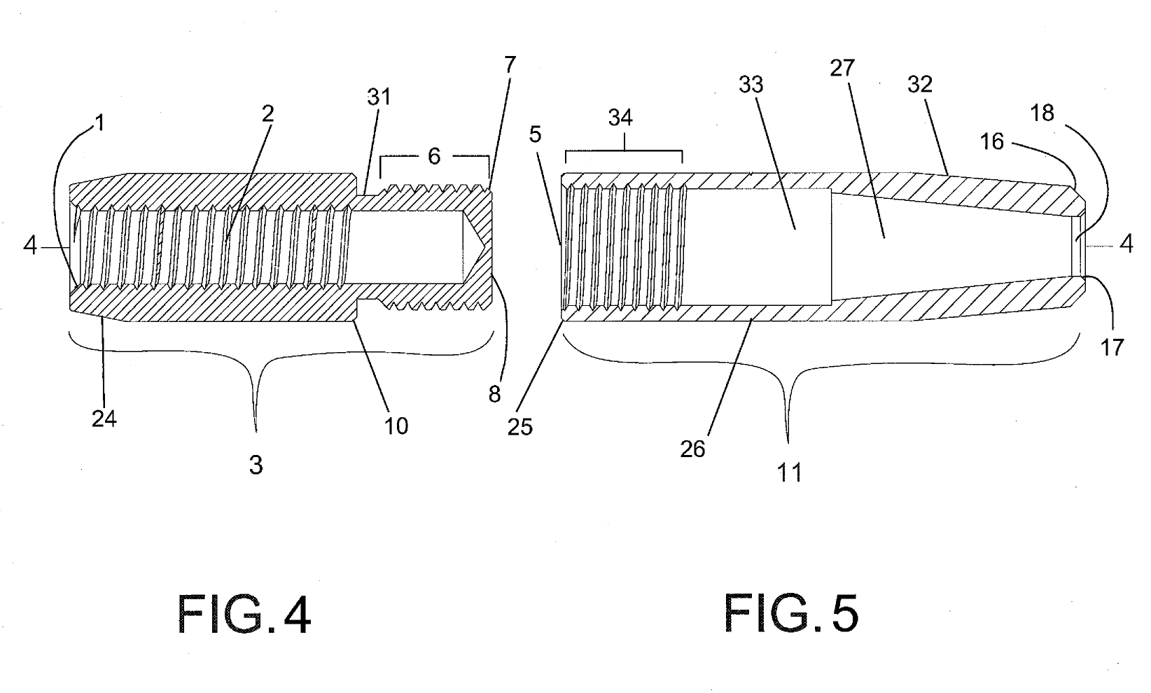

Referring now to FIG. 4, a cross-sectional view of the adaptor component 3 of the apparatus taken along the line 5-5 of FIG. 2, illustrates an inside configuration of the adaptor component 3, according to an embodiment of the present invention. The adaptor component 3 comprises an inside bevel at a bore opening 1 of its receiving side 9 which extends into a threaded internal bore 2 of the adaptor component 3. The threaded internal bore 2 engages securely and interchangeable with a cable fitting, anchoring device or other hardware accessory as needed. The adaptor component 3 further comprises a flange 4 at the contact edge 10 of the adaptor, a smaller diameter outer surface 31 continuing into a threaded connector 6 and terminating at the connector end 7 having a solid end face 8.

The apparatus engages interchangeably with a variety of cable fittings or anchoring devices which comprise and are not limited to tension adjustment fittings such as threaded terminals, turnbuckles, and adjusters; as well as jaw end, cap end, ball end, surface mount fittings for example. The versatility of the adaptor component 3 allows for quick interchangeability with existing threaded end fittings. Accordingly, the length of the adaptor component 3 may also be configured to have a more shortened or elongated length depending on the type of fitting or anchoring device, or application for the apparatus is required.

FIG. 5 is the corresponding cross-sectional view of the housing 11 taken along the line 6-6 of FIG. 2, illustrating the inside configuration of housing 11 itself. The view is shown without the cable gripping components normally contained within the housing 11. As shown, the bore opening 5 of the housing 11 is located on the dispatching end of the housing 11 and comprises a threaded internal bore section 34 for securely engaging with the connector 6 of the adaptor component 3. The diameter of the connector 6 is slightly smaller than the diameter of the threaded internal bore section 34, such that the connector 6 is securely threaded into the internal bore section 34 until the bore opening 5 abuts the flange 4. The diameter of the housing 11 at the dispatching/bore opening 5 end is substantially the same as the diameter of the flange 4 of the adaptor component 3. When engaged, the adaptor component 3 and housing 11 form a continuously level outer surface profile where contact edge 10 of the adaptor meets contact edge 25 of the housing 11. Both contact edges 10, 25 may be chamfered. The opening 5 extends into the bore 33 section and then a tapered bore 27 section as further showing by the outside surface profile of the housing having a tapered end 32. The tapering of the housing 11 ends at the cable receiving end 18 having a beveled inside end 17 and a beveled outside end 16 which facilitates the receiving of the cable into the housing 11. Beveled inside end 17 has a smaller diameter than the beveled outside end 16. Further, chamfered contact edge 25 is located at the bore opening 5 at the dispatching end of the housing 11.

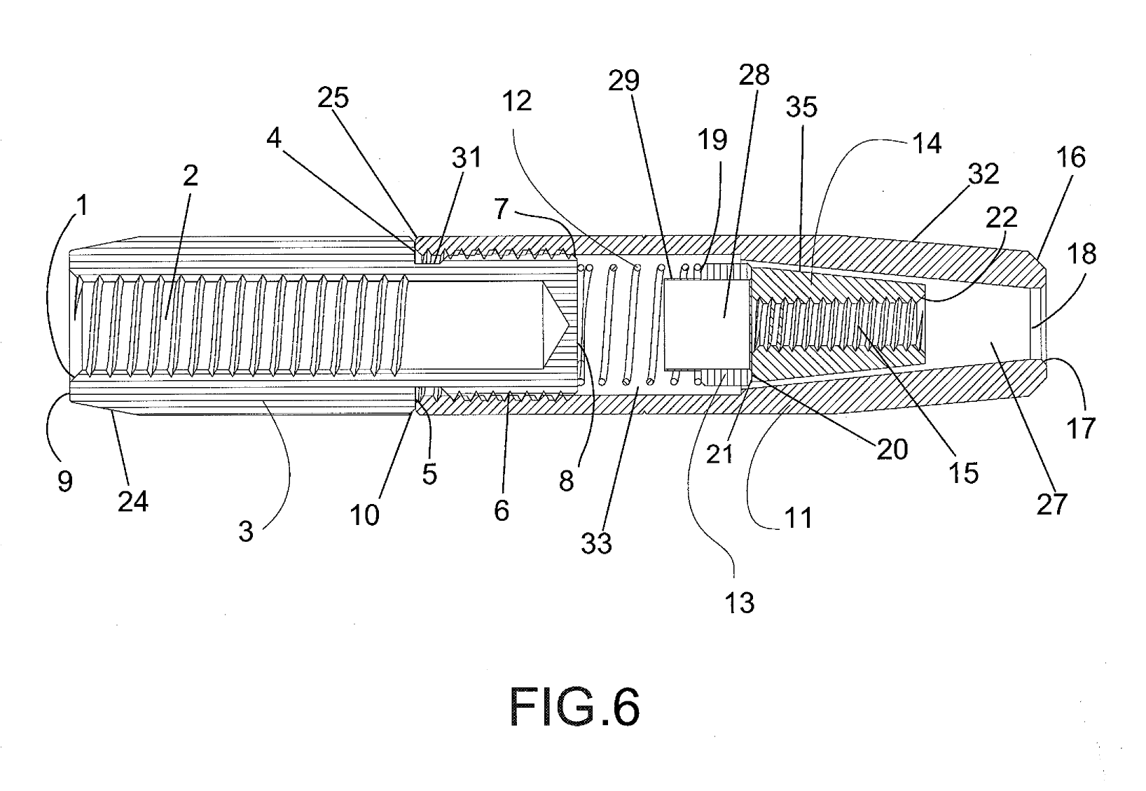

In an engaged and assembled form, the apparatus is shown in FIG. 6 in a cross-sectional view taken along the line 4-4 of FIG. 1. The view illustrates the components that are contained within the assembly of the apparatus, according to an embodiment of the present invention. As shown, the adaptor component 3 is engaged with the housing 11 with gripping components, such that the flange 4 of the adaptor rests substantially flush against the bore opening 5, i.e. the edge of the dispatching end of the housing 11. The end face 8 of the adaptor component 3 abuts the spring 12 inside the housing 11. The diameter of the end face 8 being larger than the diameter of the spring 12. In turn, the spring 12 rests against the spacer 13 and around the smaller outer surface circumference 29 such that the spring diameter is no larger than the spacer flange 21. The spacer 13 further comprises a spacer opening 28 or passageway allowing the cable to dispatch through, through the spring 12 until reaching the end face 8. The end face 8 and spacer 13, thereby contain the spring 12 and directly apply compressive forces to the respective ends of the spring 12. The larger diameter spacer end 20 rests against the pair of half jaws 14. The half jaws 14 have a conically tapered and serrated/threaded inner surface 15 for gripping upon a received cable and has a similar tapered profile as shown in the tapered outer surface circumference 35 of the jaws 14 which further coincides with the internal tapered bore shape 27 and outside tapered end 32 of the housing 11.

The outer surface of the apparatus is not limited to the particular profile shown, and can be embodied in a variety shapes while maintaining the internal tapered configuration. As pressure is applied to the pair of jaws 14 when the cable is received, the jaws 14 slide longitudinally toward the larger bore section 33 from the smaller tapered bore section 27 and the jaws 14 begin to move radially apart to accommodate the size of the cable entering. The tapered jaws 14 and tapered bore shaped 27 section of the housing further cause the cable to more in one direction inward toward the dispatching end and not in the other direction therefore causing the apparatus to self-lock upon the cable. In an embodiment of the present invention, the larger bore section 33 of the housing begins from the dispatching end 5 and has a constant bore diameter wherein the spring 12 and spacer 13 reside. The jaws 14 taper to a beveled drawing end 22 to further facilitate drawing in the cable. The adapter component 3 end face 8 serves as a containment of the gripping component parts, applying the needed pressure against the jaws 14 and preventing passage of the various gripping components in the opposite direction. The bore at the cable receiving end 18 has a smaller diameter than the smallest diameter of the conical shape of jaws 14, therein preventing bypass of any component out from the apparatus.

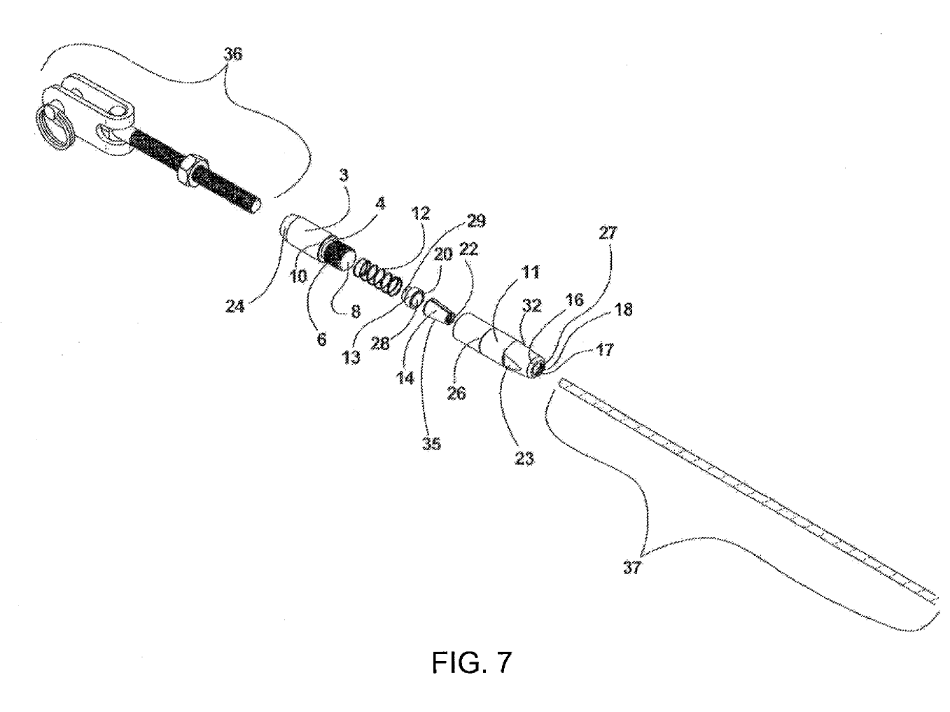

FIG. 7 is an exploded perspective view of the apparatus illustrating connection with sample accessories at each end respectively, according to an embodiment of the present invention. As shown, there is a jaw end fitting 36 with threaded terminal and nut for engaging securely with the adaptor component 3 of the apparatus. As further shown, cable material 37 enters the housing 11 of the apparatus from the receiving end 18, the pressure from the cable material causes the pair of jaws 14 to open, thus allowing the cable to enter the apparatus. The pressure from the cable also causes the spring 12 to be compressed at the dispatching end against the end face 8 of the adaptor component 3, and which applies pressure against the spacer 13 which in turn presses against the jaws 14 against the cable. The jaws 14 slide longitudinally toward the dispatching end and begin to separate. As the jaws 14 open, the cable is received through the passageway until the spring 12 is expanded. The applied pressure of the spring 12 to the spacer 13 and the spacer 13 to the jaws 14 keeps the receiving end of the jaws 14 in place by causing the jaws 14 to close, thus securely gripping the cable. The tapered bore 27 of the housing 11 further maintains the mechanism of the jaws to keep the cable in place. Thus, the cable is locked within the apparatus and can only move from the receiving end to the dispatching end.

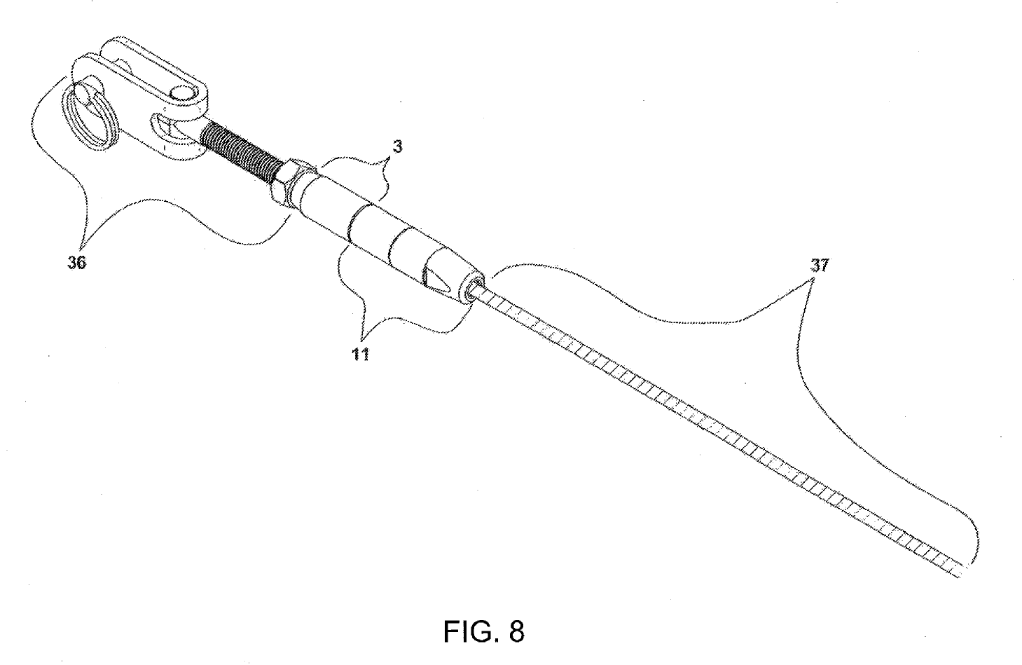

FIG. 8 is an assembled perspective view of the apparatus as shown in FIG. 7, according to an embodiment of the present invention. As illustrated, accessory 36, herein shown as a jaw end fitting 36, but may be selected from a variety of fittings and anchoring devices or connections as required by design and functional requirements of the structure, is engaged with the adaptor component 3 of the apparatus. The apparatus is further engaged with the cable 37 as locked inside the gripping components of the housing 11, forming a sleek and streamlined assembly.

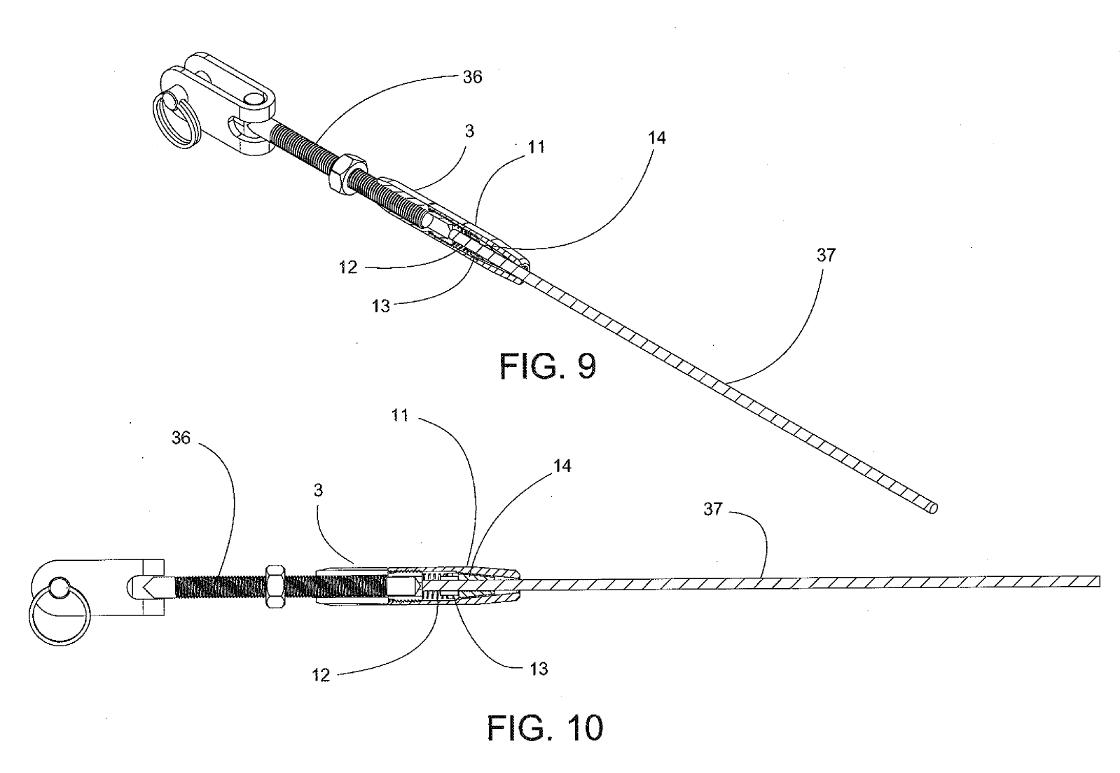

FIGS. 9 and 10 illustrate a perspective and side elevational view of the apparatus with sample accessories as illustrated in FIG. 8 with cross-section of the apparatus taken along the line 4-4 of FIG. 1, according to an embodiment of the present invention. The cross-sectional views more particularly illustrate how the inner elements function in combination with the many accessories that are available such as sample accessories 36 and 37. As shown, the apparatus secures cable 37 as it is received through the housing 11 via the gripping components comprising jaws 14, through spacer 13 and through spring 12, until it rests against the end face 8 of the adaptor component 3. Simultaneously, the apparatus engages with the fitting 36 which is interchangeably threaded into the adaptor component 3 of the apparatus.

Accordingly, the apparatus may be used both internally or externally of a structure and still maintain an attractive and continuous look while allowing for versatility in changing the fitting/anchoring device. The material of all elements may comprise of stainless steel for strength and durability. The configuration of the apparatus components further lends itself to an easy to use, low maintenance, cost effective, lightweight yet strong apparatus. The internal components of the apparatus are further protected from elements and corrosive contaminants from entering the housing passageway. The apparatus may be used in all types of applications including wood, steel and aluminum structures as example.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. An apparatus for gripping and anchoring a cable comprising: a first component including a housing for containing a plurality of cable gripping elements, the housing having a passageway, a receiving end and a dispatching end, the gripping elements receive the cable through the receiving end and passageway, preventing the cable from moving back out in an opposite direction; and a second component having an open end, a central bore, and a closed end, a portion of the second component at the closed end is configured for secure attachment by insertion into the dispatching end of the first component, the second component configured for adapting interchangeably with a plurality of types of anchoring devices inserted through the open end and into the central bore, and the closed end positioned adjacent to the gripping elements contained inside the housing at the dispatching end.

2. The apparatus for gripping and anchoring cable according to claim 1, wherein the plurality of cable gripping elements comprise a pair of half jaws housed within the housing, a spacer positioned within the housing against the pair of half jaws, and a spring positioned within the housing against the spacer; such that a cable entering the receiving end is advanced through the housing through the half jaws, compressing the spring upon the closed end of the second component, the spring in turn exerting a force upon the spacer and half jaws thereby self-locking the cable.

3. The apparatus for gripping and anchoring cable according to claim 1, wherein the passageway of the housing comprises a larger bore section next to a smaller bore section; the larger bore section beginning from the dispatching end having a constant bore diameter and the smaller bore section tapering in diameter from the larger bore section to the receiving end; and the central bore of the second component comprises a threaded internal surface for receiving and securing one of the plurality of types of anchoring devices received through the open end.

4. The apparatus for gripping and anchoring cable according to claim 3, wherein the second component comprises an elongated flange section, and the portion of the second component configured for insertion into the dispatching end of the first component comprises a threaded outer surface for securely fitting inside the larger bore section of the housing.

5. The apparatus for gripping and anchoring cable according to claim 4, wherein the larger bore section of the housing comprises a threaded internal surface for engaging around the threaded outer surface of the portion of the second component, such that an edge of the dispatching end of the housing, abuts the flange section.

6. The apparatus for gripping and anchoring cable according to claim 1, wherein the second component further comprises an inner beveled edge on the open end; and the housing further comprises an outside bevel and an inside bevel on the receiving end, the inside bevel having a smaller diameter than a diameter of the outside bevel.

7. The apparatus for gripping and anchoring cable according to claim 1, wherein the second component comprises a flange section, and the housing at the dispatching end having a diameter substantially the same as the diameter of the flange section, such that when the portion of the second component at the closed end is inserted into the dispatching end of the housing, an edge of the dispatching end, abuts the flange section.

8. A self-locking cable gripping and anchoring apparatus comprising: an adaptor component having a central bore, an open first end for interchangeably connecting with one of a plurality of different anchoring accessories inserted longitudinally through the open first end into the central bore, and a closed second end terminating with an end face; and a spring loaded cable gripping component including a housing having a central passage, an open receiving end and an open dispatching end; a pair of half jaws housed within the housing, a spacer positioned within the housing against the pair of half jaws, a spring positioned within the housing against the spacer, such that a cable entering the receiving end is advanced through the housing through the half jaws, compressing the spring upon the end face of the adaptor component, the spring in turn exerting a force upon the spacer and jaws thereby self-locking the cable; and wherein the adaptor component is engaged securely at the closed second end within the open dispatching end of the gripping component such that the adaptor component and gripping component form a continuously level outer surface profile when engaged.

9. The self-locking cable gripping and anchoring apparatus according to claim 8, wherein the passage of the housing comprises a larger bore section next to a smaller bore section; the larger bore section beginning from the open dispatching end and having a constant bore diameter, and the smaller bore section tapering in diameter from the larger bore section to the receiving end; and wherein the half jaws are housed within the smaller bore section and slidable along an axial length of the passage toward the larger bore section as the cable is advanced into the jaws, exerting pressure on the spring until the jaws separate for receiving the cable.

10. The self-locking cable gripping and anchoring apparatus according to claim 9, wherein the adaptor component comprises an elongated flange section, and the closed second end includes a threaded outer surface section for insertion into the larger bore section of the housing.

11. The self-locking cable gripping and anchoring apparatus according to claim 10, wherein the larger bore section of the housing comprises a threaded internal surface for engaging around the threaded outer surface section of the adaptor component, such that an edge of the open dispatching end of the housing, abuts the flange section.

12. The self-locking cable gripping and anchoring apparatus according to claim 11, wherein the edge of the open dispatching end of the housing is beveled and a contacting edge of the flange section is beveled.

13. The self-locking cable gripping and anchoring apparatus according to claim 8, wherein the adaptor component further comprises an inner beveled edge on the open first end; and the housing further comprises an outside bevel and an inside bevel on the open receiving end, the inside bevel having a smaller diameter than a diameter of the outside bevel.

14. The self-locking cable gripping and anchoring apparatus according to claim 8, wherein the pair of half jaws have a serrated inside surface which contacts the cable when inserted into the apparatus, and the central bore of the adaptor component comprises a threaded internal surface for receiving and securing one of the plurality of different anchoring accessories received through the open first end.

15. An interchangeable cable gripping and adaptor apparatus comprising: a cylindrical adaptor component having an open first end, an outside flange section, an outside threaded connector section of a smaller diameter than a diameter of the flange section, a threaded central bore and a closed second end; and a spring loaded cable gripping component including a housing having a central passage, an open receiving end and an open dispatching end, the housing at the dispatching end having a diameter substantially the same as the diameter of the flange section; a pair of half jaws housed within the housing, a spacer positioned within the housing against the pair of half jaws, a spring positioned within the housing against the spacer, such that a cable entering the open receiving end is advanced through the housing through the half jaws, compressing the spring upon the closed second end of the adaptor component, the spring in turn exerting a force upon the spacer and jaws thereby self-locking the cable; and wherein the outside threaded connector section of the adaptor component is engaged securely inside the central passage of the housing through the open dispatching end such that the housing of the gripping component rests flush against the flange section of the adaptor component.

16. The interchangeable cable gripping and adaptor apparatus according to claim 15, wherein the open first end interchangeably accepts one of a plurality of different anchoring accessories inserted longitudinally through the open first end and received by the threaded central bore.

17. The interchangeable cable gripping and adaptor apparatus according to claim 15, wherein the adaptor component and gripping component form a continuously level outer surface profile when engaged.

18. The interchangeable cable gripping and adaptor apparatus according to claim 15, wherein the adaptor component further comprises an inner beveled edge on the open first end; and the housing further comprises an outside bevel and an inside bevel on the open receiving end, the inside bevel having a smaller diameter than a diameter of the outside bevel.

19. The interchangeable cable gripping and adaptor apparatus according to claim 15, wherein the entire apparatus is comprised of stainless steel.

20. The interchangeable cable gripping and adaptor apparatus according to claim 15, wherein the central passage of the housing comprises a part conical shaped inner circumference.
